(19) United States
(12) Patent Application Publication
(10) Pub. No.: US 2025/0373809 A1
(43) Pub. Date: Dec. 4, 2025

(54) METHOD AND APPARATUS FOR ENCODING/DECODING IMAGE AND RECORDING MEDIUM FOR STORING BITSTREAM

(71) Applicants: HYUNDAI MOTOR COMPANY, Seoul (KR); KIA CORPORATION, Seoul (KR)

(72) Inventors: Jin Heo, Yongin-si (KR); Seung Wook Park, Yongin-si (KR)

(73) Assignees: HYUNDAI MOTOR COMPANY, Seoul (KR); KIA CORPORATION, Seoul (KR)

(21) Appl. No.: 18/861,796

(22) PCT Filed: Jun. 23, 2023
(86) PCT No.: PCT/KR2023/008735

§ 371 Date: Aug. 16, 2025

(30) Foreign Application Priority Data
Jun. 27, 2022 (KR) 10-2022-0078062
Jun. 23, 2023 (KR) 10-2023-0080848

(51) Int. Cl. H04N 19/139; H04N 19/105; H04N 19/119; H04N 19/176; H04N 19/513

(52) U.S. Cl. CPC H04N 19/139; H04N 19/105; H04N 19/119; H04N 19/176; H04N 19/513

(57) ABSTRACT

An image encoding/decoding method and apparatus, a recording medium storing a bitstream and a transmission method are provided. The image decoding method comprises searching for a reference block for each neighboring block based on motion vectors of a plurality of neighboring blocks neighboring a current block, determining a corresponding reference block of the current block based on a distortion value of the searched reference block; and deriving a sub-block-unit motion vector of the current block from the corresponding reference block.

### CROSS-REFERENCE TO RELATED APPLICATION

This application is a U.S. national stage of International Application No. PCT/KR2023/008735, filed on Jun. 23, 2023, which claims priority to Korean Patent Application No. 10-2022-0078062, filed on Jun. 27, 2022, and Korean Patent Application No. 10-2023-0080848, filed on Jun. 23, 2023, the entire contents of each of which are hereby incorporated herein by reference.

### TECHNICAL FIELD

The present invention relates to an image encoding/decoding method and apparatus and a recording medium for storing a bitstream. More particularly, the present invention relates to an image encoding/decoding method and apparatus using bidirectional intra prediction and a recording medium for storing a bitstream.

### BACKGROUND

Recently, the demand for high-resolution, high-quality images such as ultra-high definition (UHD) images is increasing in various application fields. As image data becomes higher in resolution and quality, the amount of data increases relatively compared to existing image data. Therefore, when transmitting image data using media such as existing wired and wireless broadband lines or storing image data using existing storage media, the transmission and storage costs increase. In order to solve these problems that occur as image data becomes higher in resolution and quality, high-efficiency image encoding/decoding technology for images with higher resolution and quality is required.

### SUMMARY

An object of the present invention is to provide an image encoding/decoding method and apparatus with improved encoding/decoding efficiency.

Another object of the present invention is to provide a recording medium for storing a bitstream generated by an image decoding method or apparatus according to the present invention.

Another object of the present invention is to provide an improved sub-block-based temporal motion vector prediction method.

A image decoding method according to an embodiment of the present invention may comprise searching for a reference block for each neighboring block based on motion vectors of a plurality of neighboring blocks neighboring a current block, determining a corresponding reference block of the current block based on a distortion value of the searched reference block; and deriving a sub-block-unit motion vector of the current block from the corresponding reference block.

In the image decoding method, the distortion value may be a distortion value between a template for the searched reference block and a template of the current block.

In the image decoding method, the distortion value may be a distortion value between a pixel for the searched reference block and a pixel of the current block.

In the image decoding method, the reference block and the corresponding reference block may be included in a collocated reference picture different from a current picture including the current block.

In the image decoding method, the searching for the reference block may comprise searching for the reference block using only neighboring blocks having the same reference picture as the collocated reference picture among the plurality of neighboring blocks.

In the image decoding method, the plurality of neighboring blocks may include a left neighboring block, a bottom-left neighboring block, a top-left neighboring block, a top neighboring block and a top-right neighboring block of the current block.

In the image decoding method, the deriving the sub-block-unit motion vector may comprise partitioning the current block into a plurality of sub-blocks and deriving the sub-block-unit motion vector from the corresponding reference sub-block in the corresponding reference block corresponding to the sub-block.

In the image decoding method, the sub-block-unit motion vector may be derived based on a motion vector at a center position of the corresponding reference sub-block.

In the image decoding method, the sub-block-unit motion vector may be derived based on a motion vector of at least one neighboring sub-block of the corresponding reference sub-block when a motion vector does not exist in the corresponding reference sub-block.

In the image decoding method, the sub-block-unit motion vector may be set to a motion vector at a center position of the corresponding reference block when a motion vector does not exist in the corresponding reference sub-block.

An image encoding method according to an embodiment of the present invention may comprise searching for a reference block for each neighboring block based on motion vectors of a plurality of neighboring blocks neighboring a current block, determining a corresponding reference block of the current block based on a distortion value of the searched reference block, and deriving a sub-block-unit motion vector of the current block from the corresponding reference block.

A non-transitory computer-readable recording medium according to an embodiment of the present invention may store a bitstream generated by an image encoding method comprising searching for a reference block for each neighboring block based on motion vectors of a plurality of neighboring blocks neighboring a current block, determining a corresponding reference block of the current block based on a distortion value of the searched reference block, and deriving a sub-block-unit motion vector of the current block from the corresponding reference block.

A transmission method according to an embodiment of the present invention may transmit a bitstream generated by an image encoding method comprising searching for a reference block for each neighboring block based on motion vectors of a plurality of neighboring blocks neighboring a current block, determining a corresponding reference block of the current block based on a distortion value of the searched reference block, and deriving a sub-block-unit motion vector of the current block from the corresponding reference block.

The features briefly summarized above with respect to the present disclosure are merely exemplary aspects of the detailed description below of the present disclosure, and do not limit the scope of the present disclosure.

According to the present invention, it is possible to provide an image encoding/decoding method and apparatus with improved encoding/decoding efficiency.

In addition, according to the present invention, it is possible to provide an improved sub-block-based temporal motion vector prediction method.

In addition, according to the present invention, it is possible to efficiently determine a corresponding reference block corresponding to a current block to derive a motion vector used in a sub-block within the current block.

It will be appreciated by persons skilled in the art that that the effects that can be achieved through the present disclosure are not limited to what has been particularly described hereinabove and other advantages of the present disclosure will be more clearly understood from the detailed description.

### BRIEF DESCRIPTION OF THE DRAWINGS

FIG. 1 is a block diagram showing a configuration of an encoding apparatus an embodiment of the present invention.

FIG. 2 is a block diagram showing a configuration of a decoding apparatus according to an embodiment of the present invention.

FIG. 3 is a diagram schematically showing a video coding system to which the present invention is applicable.

FIG. 4 is a flowchart of a sub-block-based temporal motion vector prediction method according to an embodiment of the present invention.

FIGS. 5 to 8 are diagrams for explaining a method of determining a corresponding reference block according to an embodiment of the present invention.

FIG. 9 is a diagram illustrating a spatial neighboring block of a current block according to an embodiment of the present invention.

FIG. 10 is a diagram for explaining a method of deriving a sub-block-unit motion vector according to an embodiment of the present invention.

FIG. 11 is a flowchart illustrating an image decoding method according to an embodiment of the present invention.

FIG. 12 exemplarily illustrates a content streaming system to which an embodiment according to the present invention is applicable.

### DETAILED DESCRIPTION

The present invention may have various modifications and embodiments, and specific embodiments are illustrated in the drawings and described in detail in the detailed description. However, this is not intended to limit the present invention to specific embodiments, but should be understood to include all modifications, equivalents, or substitutes included in the spirit and technical scope of the present invention. Similar reference numerals in the drawings indicate the same or similar functions throughout various aspects. The shapes and sizes of elements in the drawings may be provided by way of example for a clearer description. The detailed description of the exemplary embodiments described below refers to the accompanying drawings, which illustrate specific embodiments by way of example. These embodiments are described in sufficient detail to enable those skilled in the art to practice the embodiments. It should be understood that the various embodiments are different from each other, but are not necessarily mutually exclusive. For example, specific shapes, structures, and characteristics described herein may be implemented in other embodiments without departing from the spirit and scope of the present invention with respect to one embodiment. It should also be understood that the positions or arrangements of individual components within each disclosed embodiment may be changed without departing from the spirit and scope of the embodiment. Accordingly, the detailed description set forth below is not intended to be limiting, and the scope of the exemplary embodiments is defined only by the appended claims, along with the full scope of equivalents to which such claims are entitled, if properly described.

In the present invention, the terms first, second, etc. may be used to describe various components, but the components should not be limited by the terms. The terms are only used for the purpose of distinguishing one component from another. For example, without departing from the scope of the present invention, the first component may be referred to as the second component, and similarly, the second component may also be referred to as the first component. The term and/or includes a combination of a plurality of related described items or any item among a plurality of related described items.

The components shown in the embodiments of the present invention are independently depicted to indicate different characteristic functions, and do not mean that each component is formed as a separate hardware or software configuration unit. That is, each component is listed and included as a separate component for convenience of explanation, and at least two of the components may be combined to form a single component, or one component may be divided into multiple components to perform a function, and embodiments in which components are integrated and embodiments in which each component is divided are also included in the scope of the present invention as long as they do not deviate from the essence of the present invention.

The terminology used in the present invention is only used to describe specific embodiments and is not intended to limit the present invention. The singular expression includes the plural expression unless the context clearly indicates otherwise. In addition, some components of the present invention are not essential components that perform essential functions in the present invention and may be optional components only for improving performance. The present invention may be implemented by including only essential components for implementing the essence of the present invention excluding components only used for improving performance, and a structure including only essential components excluding optional components only used for improving performance is also included in the scope of the present invention.

In an embodiment, the term “at least one” may mean one of a number greater than or equal to 1, such as 1, 2, 3, and 4. In an embodiment, the term “a plurality of” may mean one of a number greater than or equal to 2, such as 2, 3, and 4.

Hereinafter, embodiments of the present invention will be specifically described with reference to the drawings. In describing the embodiments of this specification, if it is determined that a detailed description of a related known configuration or function may obscure the subject matter of this specification, the detailed description will be omitted, and the same reference numerals will be used for the same components in the drawings, and repeated descriptions of the same components will be omitted.

### Description of Terms

Hereinafter, “image” may mean one picture constituting a video, and may also refer to the video itself. For example, “encoding and/or decoding of an image” may mean “encoding and/or decoding of a video,” and may also mean “encoding and/or decoding of one of images constituting the video.”

Hereinafter, “moving image” and “video” may be used with the same meaning and may be used interchangeably. In addition, a target image may be an encoding target image that is a target of encoding and/or a decoding target image that is a target of decoding. In addition, the target image may be an input image input to an encoding apparatus and may be an input image input to a decoding apparatus. Here, the target image may have the same meaning as a current image.

Hereinafter, encoder and image encoding apparatus may be used with the same meaning and may be used interchangeably.

Hereinafter, decoder and image decoding apparatus may be used with the same meaning and may be used interchangeably.

Hereinafter, “image”, “picture”, “frame” and “screen” may be used with the same meaning and may be used interchangeably.

Hereinafter, a “target block” may be an encoding target block that is a target of encoding and/or a decoding target block that is a target of decoding. In addition, the target block may be a current block that is a target of current encoding and/or decoding. For example, “target block” and “current block” may be used with the same meaning and may be used interchangeably.

Hereinafter, “block” and “unit” may be used with the same meaning and may be used interchangeably. In addition, “unit” may mean including a luma component block and a chroma component block corresponding thereto in order to distinguish it from a block. For example, a coding tree unit (CTU) may be composed of one luma component (Y) coding tree block (CTB) and two chroma component (Cb, Cr) coding tree blocks related to it.

Hereinafter, “sample”, “picture element” and “pixel” may be used with the same meaning and may be used interchangeably. Herein, a sample may represent a basic unit that constitutes a block.

Hereinafter, “inter” and “inter-screen” may be used with the same meaning and can be used interchangeably.

Hereinafter, “intra” and “in-screen” may be used with the same meaning and can be used interchangeably.

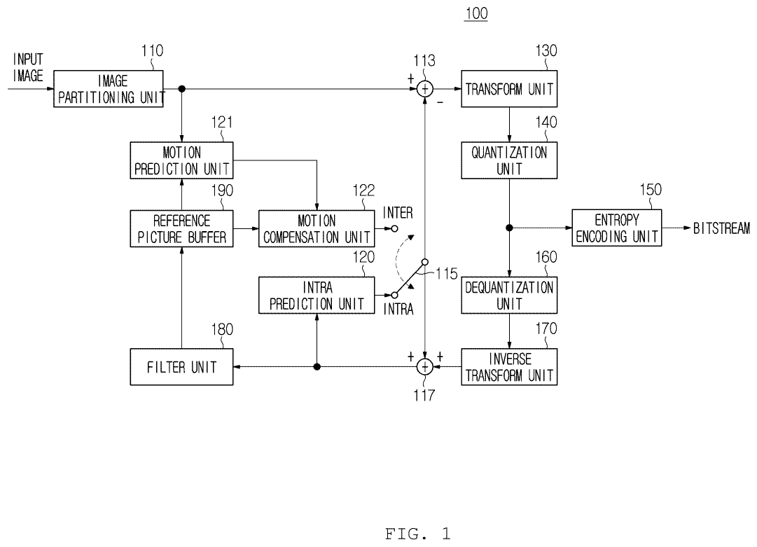

FIG. 1 is a block diagram showing a configuration of an encoding apparatus according to an embodiment of the present invention.

The encoding apparatus 100 may be an encoder, a video encoding apparatus, or an image encoding apparatus. A video may include one or more images. The encoding apparatus 100 may sequentially encode one or more images.

Referring to FIG. 1, the encoding apparatus 100 may include an image partitioning unit 110, an intra prediction unit 120, a motion prediction unit 121, a motion compensation unit 122, a switch 115, a subtractor 113, a transform unit 130, a quantization unit 140, an entropy encoding unit 150, a dequantization unit 160, an inverse transform unit 170, an adder 117, a filter unit 180 and a reference picture buffer 190.

In addition, the encoding apparatus 100 may generate a bitstream including information encoded through encoding of an input image, and output the generated bitstream. The generated bitstream may be stored in a computer-readable recording medium, or may be streamed through a wired/wireless transmission medium.

The image partitioning unit 110 may partition the input image into various forms to increase the efficiency of video encoding/decoding. That is, the input video is composed of multiple pictures, and one picture may be hierarchically partitioned and processed for compression efficiency, parallel processing, etc. For example, one picture may be partitioned into one or multiple tiles or slices, and then partitioned again into multiple CTUs (Coding Tree Units). Alternatively, one picture may first be partitioned into multiple sub-pictures defined as groups of rectangular slices, and each sub-picture may be partitioned into the tiles/slices. Here, the sub-picture may be utilized to support the function of partially independently encoding/decoding and transmitting the picture. Since multiple sub-pictures may be individually reconstructed, it has the advantage of easy editing in applications that configure multi-channel inputs into one picture. In addition, a tile may be divided horizontally to generate bricks. Here, the brick may be utilized as the basic unit of parallel processing within the picture. In addition, one CTU may be recursively partitioned into quad trees (QTs), and the terminal node of the partition may be defined as a CU (Coding Unit). The CU may be partitioned into a PU (Prediction Unit), which is a prediction unit, and a TU (Transform Unit), which is a transform unit, to perform prediction and partition. Meanwhile, the CU may be utilized as the prediction unit and/or the transform unit itself. Here, for flexible partition, each CTU may be recursively partitioned into multi-type trees (MTTs) as well as quad trees (QTs). The partition of the CTU into multi-type trees may start from the terminal node of the QT, and the MTT may be composed of a binary tree (BT) and a triple tree (TT). For example, the MTT structure may be classified into a vertical binary split mode (SPLIT_BT_VER), a horizontal binary split mode (SPLIT_BT_HOR), a vertical ternary split mode (SPLIT_TT_VER), and a horizontal ternary split mode (SPLIT_TT_HOR). In addition, a minimum block size (MinQTSize) of the quad tree of the luma block during partition may be set to 16×16, a maximum block size (MaxBtSize) of the binary tree may be set to 128×128, and a maximum block size (MaxTtSize) of the triple tree may be set to 64×64. In addition, a minimum block size (MinBtSize) of the binary tree and a minimum block size (MinTtSize) of the triple tree may be specified as 4×4, and the maximum depth (MaxMttDepth) of the multi-type tree may be specified as 4. In addition, in order to increase the encoding efficiency of the I slice, a dual tree that differently uses CTU partition structures of luma and chroma components may be applied. On the other hand, in P and B slices, the luma and chroma CTBs (Coding Tree Blocks) within the CTU may be partitioned into a single tree that shares the coding tree structure.

The encoding apparatus 100 may perform encoding on the input image in the intra mode and/or the inter mode. Alternatively, the encoding apparatus 100 may perform encoding on the input image in a third mode (e.g., IBC mode, Palette mode, etc.) other than the intra mode and the inter mode. However, if the third mode has functional characteristics similar to the intra mode or the inter mode, it may be classified as the intra mode or the inter mode for convenience of explanation. In the present invention, the third mode will be classified and described separately only when a specific description thereof is required.

When the intra mode is used as the prediction mode, the switch 115 may be switched to intra, and when the inter mode is used as the prediction mode, the switch 115 may be switched to inter. Here, the intra mode may mean an intra prediction mode, and the inter mode may mean an inter prediction mode. The encoding apparatus 100 may generate a prediction block for an input block of the input image. In addition, the encoding apparatus 100 may encode a residual block using a residual of the input block and the prediction block after the prediction block is generated. The input image may be referred to as a current image which is a current encoding target. The input block may be referred to as a current block which is a current encoding target or an encoding target block.

When a prediction mode is an intra mode, the intra prediction unit 120 may use a sample of a block that has been already encoded/decoded around a current block as a reference sample. The intra prediction unit 120 may perform spatial prediction for the current block by using the reference sample, or generate prediction samples of an input block through spatial prediction. Herein, the intra prediction may mean intra prediction.

As an intra prediction method, non-directional prediction modes such as DC mode and Planar mode and directional prediction modes (e.g., 65 directions) may be applied. Here, the intra prediction method may be expressed as an intra prediction mode or an intra prediction mode.

When a prediction mode is an inter mode, the motion prediction unit 121 may retrieve a region that best matches with an input block from a reference image in a motion prediction process, and derive a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 122 may generate a prediction block of the current block by performing motion compensation using a motion vector. Herein, inter prediction may mean inter-screen prediction or motion compensation.

When the value of the motion vector is not an integer, the motion prediction unit 121 and the motion compensation unit 122 may generate the prediction block by applying an interpolation filter to a partial region of the reference picture. In order to perform inter prediction or motion compensation, it may be determined whether the motion prediction and motion compensation mode of the prediction unit included in the coding unit is one of a skip mode, a merge mode, an advanced motion vector prediction (AMVP) mode, and an intra block copy (IBC) mode based on the coding unit and inter prediction or motion compensation may be performed according to each mode.

In addition, based on the above inter prediction method, an AFFINE mode of sub-PU based prediction, an SbTMVP (Subblock-based Temporal Motion Vector Prediction) mode, an MMVD (Merge with MVD) mode of PU-based prediction, and a GPM (Geometric Partitioning Mode) mode may be applied. In addition, in order to improve the performance of each mode, HMVP (History based MVP), PAMVP (Pairwise Average MVP), CIIP (Combined Intra/Inter Prediction), AMVR (Adaptive Motion Vector Resolution), BDOF (Bi-Directional Optical-Flow), BCW (Bi-predictive with CU Weights), LIC (Local Illumination Compensation), TM (Template Matching), OBMC (Overlapped Block Motion Compensation), etc. may be applied.

Among these, the AFFINE mode is a technology that is used in both AMVP and MERGE modes and also has high encoding efficiency. In in the existing video coding standard, since MC (Motion Compensation) is performed by considering only the parallel movement of blocks, it has a disadvantage in that it cannot properly compensate for motions that occur in reality, such as zoom-in/out and rotation. To supplement this, a four-parameter affine motion model using two control point motion vectors (CPMVs) and a six-parameter affine motion model using three control point motion vectors may be used and applied to inter prediction. Here, CPMV is a vector representing the affine motion model of one of the upper left, upper right, and lower left of the current block.

The subtractor 113 may generate a residual block by using a difference between an input block and a prediction block. The residual block may be called a residual signal. The residual signal may mean a difference between an original signal and a prediction signal. Alternatively, the residual signal may be a signal generated by transforming or quantizing, or transforming and quantizing a difference between the original signal and the prediction signal. The residual block may be a residual signal of a block unit.

The transform unit 130 may generate a transform coefficient by performing transform on a residual block, and output the generated transform coefficient. Herein, the transform coefficient may be a coefficient value generated by performing transform on the residual block. When a transform skip mode is applied, the transform unit 130 may skip transform of the residual block.

A quantized level may be generated by applying quantization to the transform coefficient or to the residual signal. Hereinafter, the quantized level may also be called a transform coefficient in embodiments.

For example, a 4×4 luma residual block generated through intra prediction is transformed using a base vector based on DST (Discrete Sine Transform), and transform may be performed on the remaining residual block using a base vector based on DCT (Discrete Cosine Transform). In addition, a transform block is partitioned into a quad tree shape for one block using ROT (Residual Quad Tree) technology, and after performing transform and quantization on each transformed block partitioned through ROT, a coded block flag (cbf) may be transmitted to increase encoding efficiency when all coefficients become 0.

As another alternative, the Multiple Transform Selection (MTS) technique, which selectively uses multiple transform bases to perform transform, may be applied. That is, instead of partitioning a CU into TUs through RQT, a function similar to TU partition may be performed through the sub-block Transform (SBT) technique. Specifically, SBT is applied only to inter prediction blocks, and unlike ROT, the current block may be partitioned into 1 or 14 sizes in the vertical or horizontal direction and then transform may be performed on only one of the blocks. For example, if it is partitioned vertically, transform may be performed on the leftmost or rightmost block, and if it is partitioned horizontally, transform may be performed on the topmost or bottommost block.

In addition, LFNST (Low Frequency Non-Separable Transform), a secondary transform technique that additionally transforms the residual signal transformed into the frequency domain through DCT or DST, may be applied. LFNST additionally performs transform on the low-frequency region of 4×4 or 8×8 in the upper left, so that the residual coefficients may be concentrated in the upper left.

The quantization unit 140 may generate a quantized level by quantizing the transform coefficient or the residual signal according to a quantization parameter (QP), and output the generated quantized level. Herein, the quantization unit 140 may quantize the transform coefficient by using a quantization matrix.

For example, a quantizer using QP values of 0 to 51 may be used. Alternatively, if the image size is larger and high encoding efficiency is required, the QP of 0 to 63 may be used. Also, a DQ (Dependent Quantization) method using two quantizers instead of one quantizer may be applied. DQ performs quantization using two quantizers (e.g., Q0 and Q1), but even without signaling information about the use of a specific quantizer, the quantizer to be used for the next transform coefficient may be selected based on the current state through a state transition model.

The entropy encoding unit 150 may generate a bitstream by performing entropy encoding according to a probability distribution on values calculated by the quantization unit 140 or on coding parameter values calculated when performing encoding, and output the bitstream. The entropy encoding unit 150 may perform entropy encoding of information on a sample of an image and information for decoding an image. For example, the information for decoding the image may include a syntax element.

When entropy encoding is applied, symbols are represented so that a smaller number of bits are assigned to a symbol having a high occurrence probability and a larger number of bits are assigned to a symbol having a low occurrence probability, and thus, the size of bit stream for symbols to be encoded may be decreased. The entropy encoding unit 150 may use an encoding method, such as exponential Golomb, context-adaptive variable length coding (CAVLC), context-adaptive binary arithmetic coding (CABAC), etc., for entropy encoding. For example, the entropy encoding unit 150 may perform entropy encoding by using a variable length coding/code (VLC) table. In addition, the entropy encoding unit 150 may derive a binarization method of a target symbol and a probability model of a target symbol/bin, and perform arithmetic coding by using the derived binarization method, and a context model.

In relation to this, when applying CABAC, in order to reduce the size of the probability table stored in the decoding apparatus, a table probability update method may be changed to a table update method using a simple equation and applied. In addition, two different probability models may be used to obtain more accurate symbol probability values.

In order to encode a transform coefficient level (quantized level), the entropy encoding unit 150 may change a two-dimensional block form coefficient into a one-dimensional vector form through a transform coefficient scanning method.

A coding parameter may include information (flag, index, etc.) encoded in the encoding apparatus 100 and signaled to the decoding apparatus 200, such as syntax element, and information derived in the encoding or decoding process, and may mean information required when encoding or decoding an image.

Herein, signaling the flag or index may mean that a corresponding flag or index is entropy encoded and included in a bitstream in an encoder, and may mean that the corresponding flag or index is entropy decoded from a bitstream in a decoder.

The encoded current image may be used as a reference image for another image to be processed later. Therefore, the encoding apparatus 100 may reconstruct or decode the encoded current image again and store the reconstructed or decoded image as a reference image in the reference picture buffer 190.

A quantized level may be dequantized in the dequantization unit 160, or may be inversely transformed in the inverse transform unit 170. A dequantized and/or inversely transformed coefficient may be added with a prediction block through the adder 117. Herein, the dequantized and/or inversely transformed coefficient may mean a coefficient on which at least one of dequantization and inverse transform is performed, and may mean a reconstructed residual block. The dequantization unit 160 and the inverse transform unit 170 may be performed as an inverse process of the quantization unit 140 and the transform unit 130.

The reconstructed block may pass through the filter unit 180. The filter unit 180 may apply a deblocking filter, a sample adaptive offset (SAO), an adaptive loop filter (ALF), a bilateral filter (BIF), luma mapping with chroma scaling (LMCS), etc. to a reconstructed sample, a reconstructed block or a reconstructed image using all or some filtering techniques. The filter unit 180 may be called an in-loop filter. In this case, the in-loop filter is also used as name excluding LMCS.

The deblocking filter may remove block distortion generated in boundaries between blocks. In order to determine whether or not to apply a deblocking filter, whether or not to apply a deblocking filter to a current block may be determined based on samples included in several rows or columns which are included in the block. When a deblocking filter is applied to a block, a different filter may be applied according to a required deblocking filtering strength.

In order to compensate for encoding error using sample adaptive offset, a proper offset value may be added to a sample value. The sample adaptive offset may correct an offset of a deblocked image from an original image by a sample unit. A method of partitioning a sample included in an image into a predetermined number of regions, determining a region to which an offset is applied, and applying the offset to the determined region, or a method of applying an offset in consideration of edge information on each sample may be used.

A bilateral filter (BIF) may also correct the offset from the original image on a sample-by-sample basis for the image on which deblocking has been performed.

The adaptive loop filter may perform filtering based on a comparison result of the reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the adaptive loop filter to be applied to each block may vary.

In LMCS (Luma Mapping with Chroma Scaling), luma mapping (LM) means remapping luma values through a piece-wise linear model, and chroma scaling (CS) means a technique for scaling the residual value of the chroma component according to the average luma value of the prediction signal. In particular, LMCS may be utilized as an HDR correction technique that reflects the characteristics of HDR (High Dynamic Range) images.

The reconstructed block or the reconstructed image having passed through the filter unit 180 may be stored in the reference picture buffer 190. A reconstructed block that has passed through the filter unit 180 may be a part of a reference image. That is, the reference image is a reconstructed image composed of reconstructed blocks that have passed through the filter unit 180. The stored reference image may be used later in inter prediction or motion compensation.

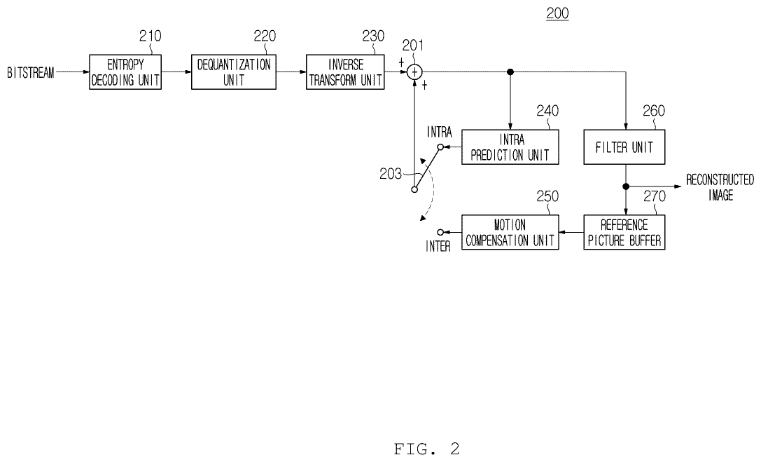

FIG. 2 is a block diagram showing a configuration of a decoding apparatus according to an embodiment of the present invention.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse transform unit 230, an intra prediction unit 240, a motion compensation unit 250, an adder 201, a switch 203, a filter unit 260, and a reference picture buffer 270.

The decoding apparatus 200 may receive a bitstream output from the encoding apparatus 100. The decoding apparatus 200 may receive a bitstream stored in a computer-readable recording medium, or may receive a bitstream that is streamed through a wired/wireless transmission medium. The decoding apparatus 200 may decode the bitstream in an intra mode or an inter mode. In addition, the decoding apparatus 200 may generate a reconstructed image generated through decoding or a decoded image, and output the reconstructed image or decoded image.

When a prediction mode used for decoding is an intra mode, the switch 203 may be switched to intra. Alternatively, when a prediction mode used for decoding is an inter mode, the switch 203 may be switched to inter.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block and the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be an inverse process of the entropy encoding method described above.

The entropy decoding unit 210 may change a one-dimensional vector-shaped coefficient into a two-dimensional block-shaped coefficient through a transform coefficient scanning method to decode a transform coefficient level (quantized level).

A quantized level may be dequantized in the dequantization unit 220, or inversely transformed in the inverse transform unit 230. The quantized level may be a result of dequantization and/or inverse transform, and may be generated as a reconstructed residual block. Herein, the dequantization unit 220 may apply a quantization matrix to the quantized level. The dequantization unit 220 and the inverse transform unit 230 applied to the decoding apparatus may apply the same technology as the dequantization unit 160 and inverse transform unit 170 applied to the aforementioned encoding apparatus.

When an intra mode is used, the intra prediction unit 240 may generate a prediction block by performing, on the current block, spatial prediction that uses a sample value of a block which has been already decoded around a decoding target block. The intra prediction unit 240 applied to the decoding apparatus may apply the same technology as the intra prediction unit 120 applied to the aforementioned encoding apparatus.

When an inter mode is used, the motion compensation unit 250 may generate a prediction block by performing, on the current block, motion compensation that uses a motion vector and a reference image stored in the reference picture buffer 270. The motion compensation unit 250 may generate a prediction block by applying an interpolation filter to a partial region within a reference image when the value of the motion vector is not an integer value. In order to perform motion compensation, it may be determined whether the motion compensation method of the prediction unit included in the corresponding coding unit is a skip mode, a merge mode, an AMVP mode, or a current picture reference mode based on the coding unit, and motion compensation may be performed according to each mode. The motion compensation unit 250 applied to the decoding apparatus may apply the same technology as the motion compensation unit 122 applied to the encoding apparatus described above.

The adder 201 may generate a reconstructed block by adding the reconstructed residual block and the prediction block. The filter unit 260 may apply at least one of inverse-LMCS, a deblocking filter, a sample adaptive offset, and an adaptive loop filter to the reconstructed block or reconstructed image. The filter unit 260 applied to the decoding apparatus may apply the same filtering technology as that applied to the filter unit 180 applied to the aforementioned encoding apparatus.

The filter unit 260 may output the reconstructed image. The reconstructed block or reconstructed image may be stored in the reference picture buffer 270 and used for inter prediction. A reconstructed block that has passed through the filter unit 260 may be a part of a reference image. That is, a reference image may be a reconstructed image composed of reconstructed blocks that have passed through the filter unit 260. The stored reference image may be used later in inter prediction or motion compensation.

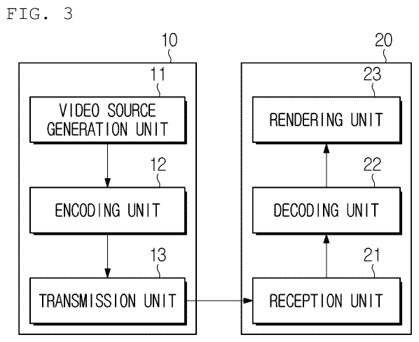

FIG. 3 is a diagram schematically showing a video coding system to which the present invention is applicable.

A video coding system according to an embodiment may include an encoding apparatus 10 and a decoding apparatus 20. The encoding apparatus 10 may transmit encoded video and/or image information or data to the decoding apparatus 20 in the form of a file or streaming through a digital storage medium or a network.

The encoding apparatus 10 according to an embodiment may include a video source generation unit 11, an encoding unit 12, a transmission unit 13. The decoding apparatus 20 according to an embodiment may include a reception unit 21, a decoding unit 22, and a rendering unit 23. The encoding unit 12 may be called a video/image encoding unit, and the decoding unit 22 may be called a video/image decoding unit. The transmission unit 13 may be included in the encoding unit 12. The reception unit 21 may be included in the decoding unit 22. The rendering unit 23 may include a display unit, and the display unit may be configured as a separate device or an external component.

The video source generation unit 11 may obtain the video/image through a process of capturing, synthesizing or generating the video/image. The video source generation unit 11 may include a video/image capture device and/or a video/image generation device. The video/image capture device may include, for example, one or more cameras, a video/image archive including previously captured video/image, etc. The video/image generation device may include, for example, a computer, a tablet and a smartphone, etc., and may (electronically) generate the video/image. For example, a virtual video/image may be generated through a computer, etc., in which case the video/image capture process may be replaced with a process of generating related data.

The encoding unit 12 may encode the input video/image. The encoding unit 12 may perform a series of procedures such as prediction, transform, and quantization for compression and encoding efficiency. The encoding unit 12 may output encoded data (encoded video/image information) in the form of a bitstream. The detailed configuration of the encoding unit 12 may also be configured in the same manner as the encoding apparatus 100 of FIG. 1 described above.

The transmission unit 13 may transmit encoded video/image information or data output in the form of a bitstream to the reception unit 21 of the decoding apparatus 20 through a digital storage medium or a network in the form of a file or streaming. The digital storage medium may include various storage media such as USB, SD, CD, DVD, Blu-ray, HDD, SSD, etc. The transmission unit 13 may include an element for generating a media file through a predetermined file format and may include an element for transmission through a broadcasting/communication network. The reception unit 21 may extract/receive the bitstream from the storage medium or the network and transmit it to the decoding unit 22.

The decoding unit 22 may decode the video/image by performing a series of procedures such as dequantization, inverse transform, and prediction corresponding to the operation of the encoding unit 12. The detailed configuration of the decoding unit 22 may also be configured in the same manner as the above-described decoding apparatus 200 of FIG. 2.

The rendering unit 23 may render the decoded video/image. The rendered video/image may be displayed through the display unit.

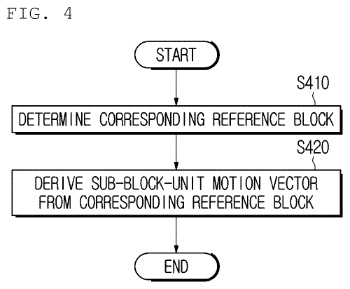

Hereinafter, with reference to FIGS. 4 to 11, a sub-block-based temporal motion vector prediction (SbTMVP) method according to an embodiment of the present invention will be specifically described.

In the present invention, temporal motion vector prediction may refer to a motion vector prediction method that derives a motion vector from a corresponding block included in a picture other than a current picture including a current block. Here, a corresponding block of a picture other than the current picture may be called a corresponding reference block, a collocated block, or a temporal neighboring block. In addition, a picture including a corresponding block used for temporal motion vector prediction may be called a collocated reference picture.

Meanwhile, spatial motion vector prediction may refer to a motion vector prediction method that derives a motion vector derived from a neighboring block of a current block. Here, the neighboring block of the current block may be referred to as a spatial neighboring block.

FIG. 4 is a flowchart of a sub-block-based temporal motion vector prediction method according to an embodiment of the present invention.

Referring to FIG. 4, the sub-block-based temporal motion vector prediction method may include a step of determining a corresponding reference block (S410) and a step of deriving a sub-block-unit motion vector from the corresponding reference block (S420), which may be performed in this order.

In step S410, a collocated position reference picture including the corresponding reference block may be derived by collocated reference picture information. The collocated reference picture information may be index information indicating a collocated reference picture used for sub-block-based temporal motion vector prediction in a reference picture list of the current block.

The collocated reference picture information may be transmitted from a picture header (PH) or a slice header (SH).

Meanwhile, the collocated reference picture information may be derived from a neighboring block of the current block.

Meanwhile, the collocated reference picture may be determined to be a reference picture of a predetermined order in the reference picture list of the current block. Here, the reference picture of the predetermined order in the reference picture list may be a first reference picture in the reference picture list.

Hereinafter, specific examples for each step of FIG. 4 will be described with reference to the drawings.

A sub-block-based temporal motion vector prediction method according to an embodiment of the present invention is a technology for increasing prediction accuracy of a motion vector by deriving a motion vector in units of blocks smaller than a current block. Therefore, determining an accurate corresponding reference block is important for increasing motion vector prediction accuracy.

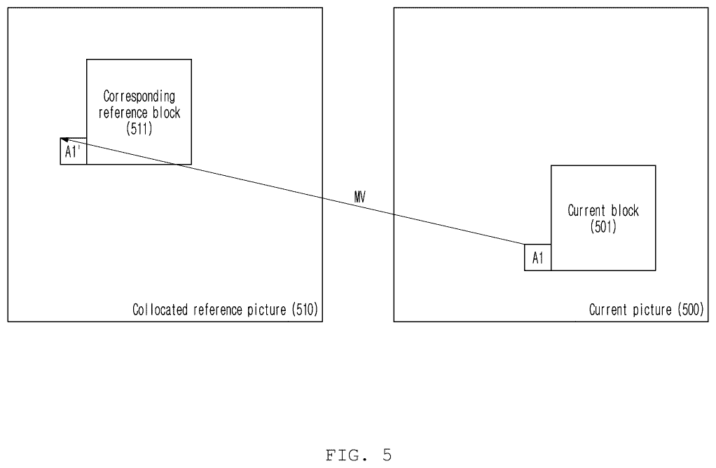

FIGS. 5 to 8 are diagrams for explaining a method of determining a corresponding reference block according to an embodiment of the present invention.

FIG. 5 is a diagram for explaining a method of determining a corresponding reference block using a motion vector of a fixed-position neighboring block according to an embodiment of the present invention.

Referring to FIG. 5, the position of a corresponding reference block 511 in a collocated reference picture 510 may be determined using a motion vector (MV) of a bottom-left block A1 which is a neighboring block of a current block 501 in a current picture 500.

If there is no motion vector in the left block A1 (i.e., not in an inter prediction mode), the position of the corresponding reference block 511 may be determined using a zero vector. Here, the zero vector may mean a (0, 0) vector.

In addition, if the reference picture of the left block A1 is not the same as the reference picture of the current block, the position of the corresponding reference block 511 may be determined using the zero vector.

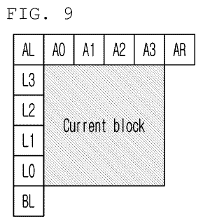

Although, in FIG. 5, the fixed-position neighboring block is described as the left block A1, the fixed-position neighboring block may be set as one of the spatial neighboring blocks of the current block and used to determine the corresponding reference block. FIG. 9 is a diagram illustrating an example of a spatial neighboring block of a current block.

The method of determining the corresponding reference block based on the fixed-position neighboring block described in FIG. 5 has the advantage of low computational complexity and fast processing speed compared to other methods.

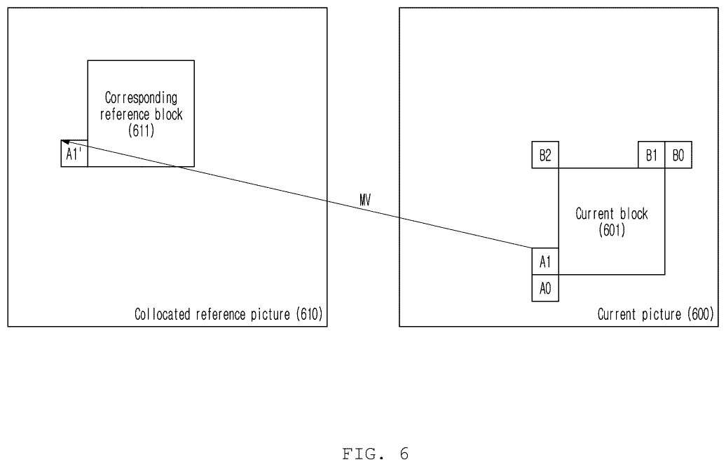

FIG. 6 is a diagram for explaining a method of determining a corresponding reference block using neighboring blocks according to an embodiment of the present invention.

Referring to FIG. 6, a corresponding reference block 611 may be determined using neighboring blocks A0, A1, B0, B1, and B2 of a current block 601 in a current picture 600. Specifically, if the reference picture of the corresponding block is identical to the reference picture of the current block while searching for neighboring blocks of the current block according to a preset search order, the position of the corresponding reference block 611 in a collocated reference picture 610 may be determined using the motion vector of the corresponding block. Here, the preset search order may be a search order B1, A1, B0, A0, B2 of spatial merge candidates.

If the reference picture of the corresponding block is not identical to the reference picture of the current block, the block of the next order may be searched. If the reference pictures of all neighboring blocks of the current block are not identical to the reference picture of the current block, the corresponding reference block may be determined using the zero vector.

Meanwhile, if the reference picture of the searched neighboring block is identical to a collocated reference picture, the corresponding reference block may be determined using the motion vector of the corresponding block, and the search may be terminated.

Meanwhile, the preset search order may be A1, B1, B0, A0, B2.

Meanwhile, the positions of the neighboring blocks may be determined to be at least one of the neighboring blocks BL, L0, L1, L2, L3, AL, A0, A1, A2, A3 and AR illustrated in FIG. 9.

Meanwhile, the number of neighboring blocks used to determine the corresponding reference block may be determined based on information transmitted from a picture header (PH) or a slice header (SH).

The method of determining the corresponding reference block based on the preset search order described in FIG. 6 may have higher prediction accuracy of the temporal motion vector compared to the method of FIG. 5.

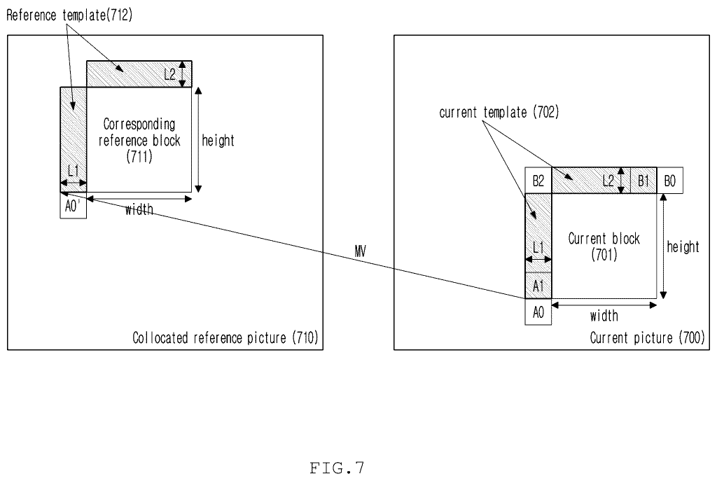

FIG. 7 is a diagram for explaining a method of determining a corresponding reference block based on template matching (TM) according to an embodiment of the present invention.

Referring to FIG. 7, respective corresponding reference blocks in a collocated reference picture 710 may be determined using motion information of neighboring blocks A0, A1, B0, B1, and B2 of a current block 701 in a current picture 700. In addition, an optimal reference block may be determined by comparing a current template 702 of the current block 701 with reference templates 712 of corresponding reference blocks. Specifically, the corresponding reference block having a minimum distortion value between the pixel of the current template 702 and the pixel of the reference template 712 may be determined to be the optimal corresponding reference block. At this time, any one of various distortion measurement methods such as a sum of absolute difference (SAD), a sum of square error (SSE), or a sum of absolute transformed difference (SATD) may be used to calculate the distortion. Here, the size of the template may be determined based on the size (width, height) of the current block. For example, the size of the left template may be L1×Height, and the size of the top template may be width×L2 (L1 and L2 are positive integers).

Meanwhile, the positions of neighboring blocks may be determined to be at least one of the neighboring blocks BL, L0, L1, L2, L3, AL, A0, A1, A2, A3 and AR shown in FIG. 9.

Meanwhile, the corresponding reference block is determined only by using neighboring blocks having the same reference picture as the collocated reference picture among the neighboring blocks of the current block, and the distortion value of the template may be calculated based on this.

Meanwhile, if the neighboring block of the current block does not have the same reference picture as the collocated reference picture, the motion vector of the neighboring block is scaled based on a ratio of a distance between the current picture and the collocated reference picture and a distance between the current picture and the reference picture of the neighboring block, and the corresponding reference block may be determined using the scaled motion vector.

Meanwhile, the corresponding reference block is determined using only the neighboring blocks having the same reference picture as the reference picture of the current block among the neighboring blocks of the current block, and the distortion value of the template may be calculated based on this.

Meanwhile, the positions of the neighboring blocks may be determined to be at least one of the neighboring blocks BL, L0, L1, L2, L3, AL, A0, A1, A2, A3 and AR shown in FIG. 9.

Meanwhile, the number of neighboring blocks used to determine the corresponding reference block may be determined based on information transmitted from a picture header (PH) or a slice header (SH).

Meanwhile, in FIG. 7, the template is defined as a template composed of a left template located on the left side of the current block and a top template located on the top side of the current block, but the corresponding reference block may be determined using a template composed in a form that further includes a top-left template located on the top-left side of the current block in addition to the left template and the top template.

Meanwhile, according to an embodiment of the present invention, the corresponding reference block may be determined using a template composed of only a left template.

Meanwhile, according to an embodiment of the present invention, the corresponding reference block may be determined using a template composed of only a top template.

Meanwhile, since the method proposed in FIGS. 5 to 7 may determine the corresponding reference block for the current block using the same method in the encoder and decoder, there is no need to transmit/parse information on the neighboring blocks of the selected current block.

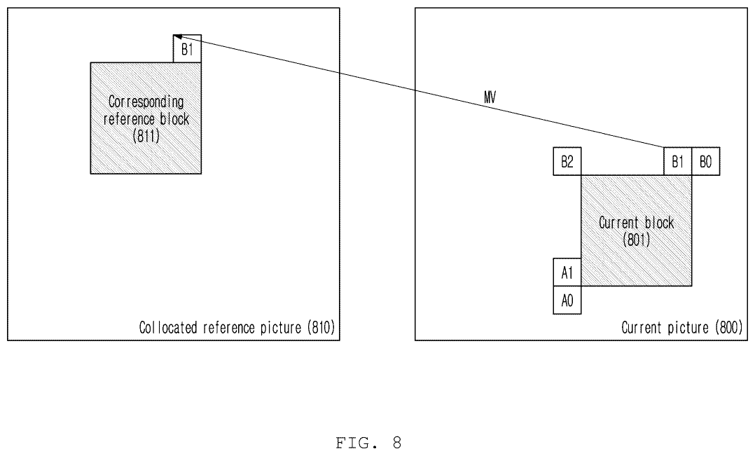

FIG. 8 is a diagram for explaining a method of determining a corresponding reference block based on block matching (BM) according to an embodiment of the present invention.

Referring to FIG. 8, respective corresponding reference blocks in a collocated reference picture 810 may be determined using motion information of neighboring blocks A0, A1, B0, B1, and B2 of a current block 801 in a current picture 800. In addition, an optimal corresponding reference block may be determined by comparing the pixels of the current block 801 with the pixels of corresponding reference blocks 811. Specifically, the corresponding reference block having a minimum distortion value between the pixels of the current block 801 and the pixels of the corresponding reference block may be determined to be the optimal corresponding reference block. At this time, any one of various distortion measurement methods such as a sum of absolute difference (SAD), a sum of square error (SSE), or a sum of absolute transformed difference (SATD) may be used to calculate the distortion.

Meanwhile, the positions of neighboring blocks may be determined to be at least one of the neighboring blocks BL, L0, L1, L2, L3, AL, A0, A1, A2, A3 and AR shown in FIG. 9.

Meanwhile, the reference block is determined using only neighboring blocks having the same reference picture as the collocated reference picture among the neighboring blocks of the current block, and the distortion value between blocks may be calculated based on this.

Meanwhile, if the neighboring block of the current block does not have the same reference picture as the collocated reference picture, the motion vector of the neighboring block is scaled based on a ratio of a distance between the current picture and the collocated reference picture and a distance between the current picture and the reference picture of the neighboring block, and the corresponding reference block may be determined using the scaled motion vector.

Meanwhile, the corresponding reference block is determined only by using neighboring blocks having the same reference picture as the reference picture of the current block among the neighboring blocks of the current block, and the distortion value between blocks may be calculated based on this.

Meanwhile, the positions of neighboring blocks may be determined to be at least one of the neighboring blocks BL, L0, L1, L2, L3, AL, A0, A1, A2, A3 and AR shown in FIG. 9.

Meanwhile, the number of neighboring blocks used to determine the corresponding reference block may be determined based on information transmitted from a picture header (PH) or a slice header (SH).

Meanwhile, the method of determining the corresponding reference block based on block matching may be performed in an encoder. The encoder transmits information on neighboring blocks used to determine the corresponding reference block to a decoder, and the decoder may parse the transmitted information on neighboring blocks to determine the corresponding reference block.

Meanwhile, depending on the number of neighboring blocks of the current block used to select the corresponding reference block, various codes such as fixed length code (FLC) or truncated unary code (TU) may be used.

In addition, when using codewords with different lengths, such as truncated unary code, since the search order of neighboring blocks of the current block is important, the search order of neighboring blocks of the current block may be determined by considering this characteristic.

The method of determining the corresponding reference block based on template matching or block matching described in FIGS. 7 and 8 may have higher prediction accuracy of temporal motion vectors than the methods of FIGS. 5 and 6.

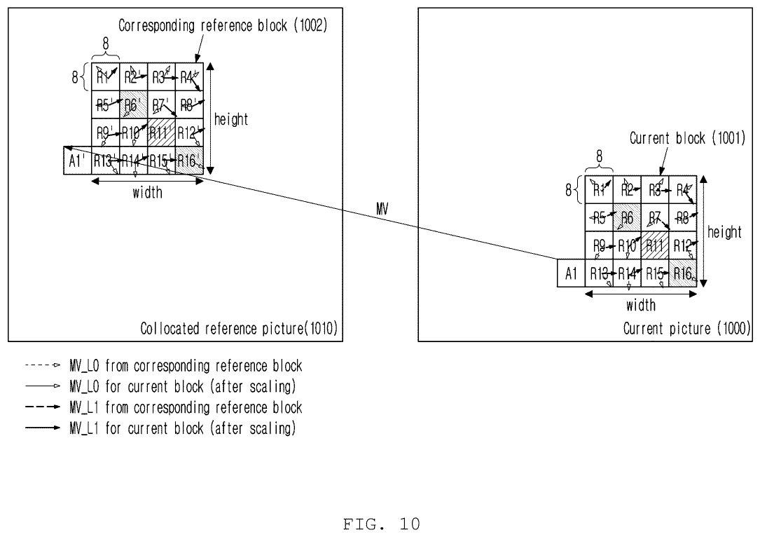

FIG. 10 is a diagram for explaining a method of deriving a sub-block-unit motion vector according to an embodiment of the present invention.

Referring to FIG. 10, in order to derive a sub-block-unit motion vector from a corresponding reference block 1002, a current block 1001 is partitioned into sub-blocks R1 to R16 with a predefined size, and a motion vector at a center position of each of corresponding reference sub-blocks R1′ to R16′ in the corresponding reference block 1002 corresponding to each sub-block position may be derived as a temporal motion vector of each sub-block.

Meanwhile, based on the POC (Picture Order Count) of the corresponding reference picture 1010 and the POC of a current picture 1000, the motion vector derived from the corresponding reference sub-block may be scaled, and the scaled motion vector may be derived as a sub-block-unit temporal motion vector. Specifically, scaling may be performed based on a ratio of a distance between the corresponding reference picture and the reference picture of the corresponding reference sub-block and a distance between the current picture and the reference picture of the current block, and the scaled motion vector may be derived as a sub-block-unit temporal motion vector.

Meanwhile, although the size of the sub-block is described as 8×8 in FIG. 10, the size of the sub-block may be determined to be N×N. Here, N is a positive integer, and may be 4, 8, or 16. Alternatively, the size of the sub-block may be determined based on information transmitted from a picture header (PH) or a slice header (SH).

Meanwhile, if a motion vector does not exist in the corresponding reference sub-block, the sub-block-unit temporal motion vector may be derived as follows.
It is replaced with a motion vector at a center position of the corresponding reference block

If a motion vector does not exist in the corresponding reference sub-block (R11′) or a motion vector in a specific prediction direction does not exist in the corresponding reference sub-block (R6′, R16′), the motion vector at the center position of the corresponding reference block may be derived as the sub-block-unit temporal motion vector of the corresponding sub-block.

Meanwhile, if a motion vector in a specific prediction direction does not exist in the corresponding reference sub-block (R6′, R16′), the motion vector in the prediction direction that does not exist may be replaced with the motion vector at the center position of the corresponding reference block to derive a sub-block-unit temporal motion vector of the corresponding sub-block. For example, if a motion vector in the L1 prediction direction does not exist in the corresponding reference sub-block, the motion vector in the L0 prediction direction of the corresponding reference sub-block and the motion vector in the L1 prediction direction at the center position of the corresponding reference block may be derived as the sub-block-unit temporal motion vector of the corresponding sub-block.
Only a motion vector in a specific prediction direction is used

If a motion vector in a specific prediction direction does not exist in the corresponding reference sub-block (R6′, R16′), only the motion vector in the prediction direction that exists may be derived as the sub-block-unit temporal motion vector of the corresponding sub-block. For example, if a motion vector in the L1 prediction direction does not exist in the corresponding reference sub-block, only the motion vector in the L0 prediction direction may be derived as the sub-block-unit temporal motion vector of the corresponding sub-block.
The corresponding reference sub-block is used as a prediction sub-block

If a motion vector does not exist in the corresponding reference sub-block (R11′) or a motion vector in a specific prediction direction does not exist in the corresponding reference sub-block (R6′, R16′), the corresponding reference sub-block may be used as a prediction sub-block of the corresponding sub-block. For example, the corresponding reference sub-block R11′ may be used as a prediction sub-block of the corresponding sub-block R11. That is, the sub-block-unit temporal motion vector of the corresponding sub-block may be replaced with a motion vector (MV) for determining the corresponding reference block 1002.
Neighboring sub-blocks of the corresponding reference sub-block are used

If a motion vector does not exist in the corresponding reference sub-block (R11′) or a motion vector in a specific prediction direction does not exist in the corresponding reference sub-block (R6′, R16′), a sub-block-unit temporal motion vector of the corresponding sub-block may be derived using the motion vectors of the neighboring sub-blocks of the corresponding reference sub-block. At this time, a sub-block-unit temporal motion vector may be derived using the motion vectors of N neighboring sub-blocks of the corresponding reference sub-block. Here, N may be any positive integer and N≤8. If N is 2 or more, any one of the minimum value, maximum value, average value, weighted average value, weighted sum value, and interpolation value of the motion vectors of the neighboring sub-blocks of the corresponding reference sub-block may be determined to be the sub-block-unit temporal motion vector.

For example, when deriving the sub-block-unit temporal motion vector using one neighboring sub-block (N=1), the motion vector of one neighboring sub-block of the corresponding reference sub-block may be used without change.

In another embodiment, when deriving the sub-block-unit temporal motion vector using two neighboring sub-blocks (N=2), the sub-block-unit temporal motion vector may be derived based on the motion vectors of two neighboring sub-blocks of the corresponding reference sub-block.

Meanwhile, the neighboring sub-block of the corresponding reference sub-block for deriving the sub-block-unit temporal motion vector may be a neighboring block at a predefined position. If a motion vector does not exist in a neighboring block at a predefined position, a zero vector may be used. For example, when deriving a sub-block-unit temporal motion vector using one neighboring sub-block (N=1), the motion vector of the left neighboring sub-block of the corresponding reference sub-block may be used without change. In another embodiment, when deriving a sub-block-unit temporal motion vector using two neighboring sub-blocks (N=2), the sub-block-unit temporal motion vector may be derived based on the motion vectors of the left neighboring sub-block and the right neighboring sub-block of the corresponding reference sub-block.

Meanwhile, the neighboring sub-blocks of the corresponding reference sub-block for deriving the sub-block-unit temporal motion vector may be determined according to a preset search order. For example, the preset search order may be the search order of the spatial merge candidates (top, left, top-right, bottom-left, top-left). If a motion vector does not exist in any of the neighboring sub-blocks, the sub-block-unit temporal motion vector may be set to a zero vector.

If the motion vector is derived by averaging the motion vectors of the sub-blocks at the right and left positions of the corresponding sub-block, the motion vector in the L1 direction of the R6′ sub-block may be determined using Equation 1.

$$R {6}_{MV\_L 1}^{′} = ( R {5}_{MV\_L 1}^{′} + R {7}_{MV\_L 1}^{′} + 1 ) ≫ 1 \qquad [ Equation 1 ]$$

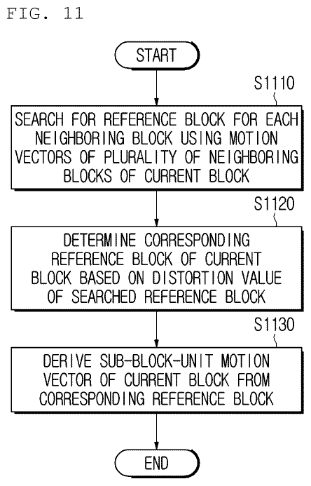

FIG. 11 is a flowchart illustrating an image decoding method according to an embodiment of the present invention. The image decoding method of FIG. 11 may be performed by an image decoding apparatus.

The image decoding apparatus may search for a reference block for each neighboring block based on motion vectors of a plurality of neighboring blocks neighboring a current block (S1110).

Specifically, the image decoding apparatus may search for a reference block using only neighboring blocks having the same reference picture as the collocated reference picture among the plurality of neighboring blocks.

Here, the plurality of neighboring blocks may include a left neighboring block, a bottom-left neighboring block, a top-left neighboring block, a top-right neighboring block, and a top-right neighboring block of the current block.

In addition, the image decoding apparatus may determine the corresponding reference block of the current block based on a distortion value of the searched reference block (S1120).

Specifically, the image decoding apparatus may determine the corresponding reference block based on the distortion value between the template for the searched reference block and the template of the current block. This was described in detail in the description of FIG. 7.

Meanwhile, according to an embodiment of the present invention, the image decoding apparatus may determine a corresponding reference block based on a distortion value between a pixel of the searched reference block and a pixel of the current block. This was described in detail in the description of FIG. 8.

Meanwhile, the reference block and the corresponding reference block may be included in a collocated reference picture different from the current picture including the current block. The collocated reference picture was described in detail in the description of FIG. 4.

In addition, the image decoding apparatus may derive the sub-block-unit motion vector of the current block from the corresponding reference block (S1130).

Specifically, the image decoding apparatus may partition the current block into a plurality of sub-blocks and derive the sub-block-unit motion vector from the corresponding reference sub-block within the corresponding reference block corresponding to the sub-block.

Meanwhile, according to an embodiment of the present invention, a sub-block-unit motion vector may be derived based on a motion vector at a center position of the corresponding reference sub-block.

Meanwhile, according to an embodiment of the present invention, the sub-block-unit motion vector may be derived based on a motion vector of at least one neighboring sub-block of the corresponding reference sub-block when a motion vector does not exist in the corresponding reference sub-block.

Meanwhile, according to an embodiment of the present invention, the sub-block-unit motion vector may be set to the motion vector at the center position of the corresponding reference block when the motion vector does not exist in the corresponding reference sub-block.

The method of deriving the sub-block-unit motion vector of the current block from the corresponding reference block was described in detail in FIG. 10.

Meanwhile, the steps described in FIG. 11 may be performed in the same manner in an image encoding method. In addition, a bitstream may be generated by an image encoding method including the steps described in FIG. 11. The bitstream may be stored in a non-transitory computer-readable recording medium, and may also be transmitted (or streamed).

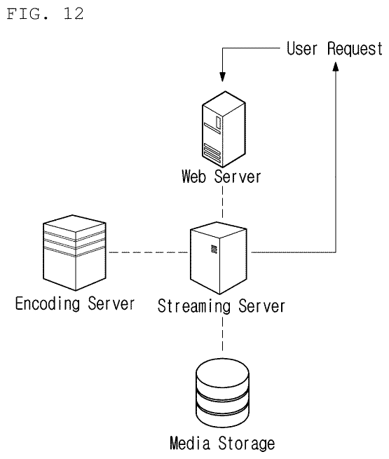

A FIG. 12 exemplarily illustrates a content streaming system to which an embodiment according to the present invention is applicable.

As illustrated in FIG. 12, a content streaming system to which an embodiment of the present invention is applied may largely include an encoding server, a streaming server, a web server, a media storage, a user device, and a multimedia input device.

The encoding server compresses content received from multimedia input devices such as smartphones, cameras, CCTVs, etc. into digital data to generate a bitstream and transmits it to the streaming server. As another example, if multimedia input devices such as smartphones, cameras, CCTVs, etc. directly generate a bitstream, the encoding server may be omitted.

The bitstream may be generated by an image encoding method and/or an image encoding apparatus to which an embodiment of the present invention is applied, and the streaming server may temporarily store the bitstream in the process of transmitting or receiving the bitstream.

The streaming server transmits multimedia data to a user device based on a user request via a web server, and the web server may act as an intermediary that informs the user of any available services. When a user requests a desired service from the web server, the web server transmits it to the streaming server, and the streaming server may transmit multimedia data to the user. At this time, the content streaming system may include a separate control server, and in this case, the control server may control commands/responses between devices within the content streaming system.

The streaming server may receive content from a media storage and/or an encoding server. For example, when receiving content from the encoding server, the content may be received in real time. In this case, in order to provide a smooth streaming service, the streaming server may store the bitstream for a certain period of time.

Examples of the user devices may include mobile phones, smartphones, laptop computers, digital broadcasting terminals, personal digital assistants (PDAs), portable multimedia players (PMPs), navigation devices, slate PCs, tablet PCs, ultrabooks, wearable devices (e.g., smartwatches, smart glasses, HMDs), digital TVs, desktop computers, digital signage, etc.

Each server in the above content streaming system may be operated as a distributed server, in which case data received from each server may be distributed and processed.

The above embodiments may be performed in the same or corresponding manner in the encoding apparatus and the decoding apparatus. In addition, an image may be encoded/decoded using at least one or a combination of at least one of the above embodiments.

The order in which the above embodiments are applied may be different in the encoding apparatus and the decoding apparatus. Alternatively, the order in which the above embodiments are applied may be the same in the encoding apparatus and the decoding apparatus.

The above embodiments may be performed for each of the luma and chroma signals. Alternatively, the above embodiments for the luma and chroma signals may be performed identically.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The embodiments may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skilled in computer software technology field.

A bitstream generated by the encoding method according to the above embodiment may be stored in a non-transitory computer-readable recording medium. In addition, a bitstream stored in the non-transitory computer-readable recording medium may be decoded by the decoding method according to the above embodiment.

Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

The present invention may be used in an apparatus for encoding/decoding an image and a recording medium for storing a bitstream.

1. An image decoding method comprising:
searching for a reference block for each neighboring block based on motion vectors of a plurality of neighboring blocks neighboring a current block;
determining a corresponding reference block of the current block based on a distortion value of the searched reference block; and
deriving a sub-block-unit motion vector of the current block from the corresponding reference block.

2. The image decoding method of claim 1, wherein the distortion value is a distortion value between a template for the searched reference block and a template of the current block.

3. The image decoding method of claim 1, wherein the distortion value is a distortion value between a pixel for the searched reference block and a pixel of the current block.

4. The image decoding method of claim 1, wherein the reference block and the corresponding reference block are included in a collocated reference picture different from a current picture including the current block.

5. The image decoding method of claim 4, wherein the searching for the reference block comprises searching for the reference block using only neighboring blocks having the same reference picture as the collocated reference picture among the plurality of neighboring blocks.

6. The image decoding method of claim 1, wherein the plurality of neighboring blocks includes a left neighboring block, a bottom-left neighboring block, a top-left neighboring block, a top neighboring block and a top-right neighboring block of the current block.

7. The image decoding method of claim 1, wherein the deriving the sub-block-unit motion vector comprises:
partitioning the current block into a plurality of sub-blocks; and
deriving the sub-block-unit motion vector from the corresponding reference sub-block in the corresponding reference block corresponding to the sub-block.

8. The image decoding method of claim 7, wherein the sub-block-unit motion vector is derived based on a motion vector at a center position of the corresponding reference sub-block.

9. The image decoding method of claim 7, wherein the sub-block-unit motion vector is derived based on a motion vector of at least one neighboring sub-block of the corresponding reference sub-block when a motion vector does not exist in the corresponding reference sub-block.

10. The image decoding method of claim 7, wherein the sub-block-unit motion vector is set to a motion vector at a center position of the corresponding reference block when a motion vector does not exist in the corresponding reference sub-block.

11. An image encoding method comprising:
searching for a reference block for each neighboring block based on motion vectors of a plurality of neighboring blocks neighboring a current block;
determining a corresponding reference block of the current block based on a distortion value of the searched reference block; and
deriving a sub-block-unit motion vector of the current block from the corresponding reference block.

12. (canceled)

13. A method of transmitting a bitstream generated by an image encoding method, the method comprising:
transmitting the bitstream,
wherein the image encoding method comprises:
searching for a reference block for each neighboring block based on motion vectors of a plurality of neighboring blocks neighboring a current block;
determining a corresponding reference block of the current block based on a distortion value of the searched reference block; and
deriving a sub-block-unit motion vector of the current block from the corresponding reference block.
